(19) United States
(12) Patent Application Publication
(10) Pub. No.: US 2026/0360617 A1
(43) Pub. Date: Nov. 12, 2026

(54) TRANSFORMER AND WIRELESS CHARGING DEVICE USING THE SAME

(71) Applicants: LITE-ON SINGAPORE PTE. LTD., Singapore (CN); LITE-ON TECHNOLOGY CORPORATION, Taipei (TW)

(72) Inventors: Yu-Wei CHIU, Taipei (TW); Chee-Khong TIANG, Singapore (SG)

(21) Appl. No.: 19/232,914

(22) Filed: Jun. 10, 2025

(30) Foreign Application Priority Data
May 9, 2025 (CN) 202510596183.6

(51) Int. Cl. H01F 27/34; B60L 53/122; H01F 27/06; H01F 27/28

(52) U.S. Cl. CPC H01F 27/346; B60L 53/122; H01F 27/06; H01F 27/2823

(57) ABSTRACT

A transformer includes a supporting body, a plurality of magnetic conductive elements and a coil. The supporting body includes a first side and a second side. The magnetic conductive elements are disposed on the first side of the supporting body and are arranged adjacent to each other. The coil is wound on the second side of the supporting body, and the coil includes an internal threading wire extending into the first side of the supporting body.

This application claims the benefit of People’s Republic of China application Serial No. 202510596183.6, filed May 9, 2025, the subject matter of which is incorporated herein by reference.

### BACKGROUND OF THE INVENTION

### Field of the Invention

The invention relates in general to a power transmission system, and more particularly to a transformer and a wireless charging device using the transformer.

### Description of the Related Art

Wireless charging devices can be charged by electromagnetic induction, a primary coil is located in a charging station of a transmitter assembly and a secondary coil is located in a to-be-charged device of a receiver assembly. When a power is applied to the charging station, a current flows through the primary coil to create magnetic flux. When the secondary coil of the to-be-charged device is close to the primary coil, the magnetic flux is coupled to the secondary coil, thereby generating an induced current in the secondary coil. The induced current in the secondary coil charges the battery of the to-be-charged device.

However, whether it is the primary coil at the transmitting end or the secondary coil at the receiving end, the magnetic flux generated by the induced current is not uniform, inherently leading to some energy loss during the transfer and making poor charging efficiency of the wireless charging device.

### SUMMARY OF THE INVENTION

The present invention relates to a transformer and a wireless charging device using the transformer to reduce magnetic leakage and improve charging performance.

According to one aspect of the present invention, a transformer is provided. The transformer includes a supporting body, a plurality of magnetic conductive elements and a coil. The supporting body includes a first side and a second side. The magnetic conductive elements are disposed on the first side of the supporting body, and the magnetic conductive elements are arranged adjacent to each other. The coil is wound on the second side of the supporting body, and the coil includes an internal threading wire extending into the first side of the supporting body.

According to one aspect of the present invention, a wireless charging device is provided. The wireless charging device includes a power line and a transformer. The power line is used to input a power. The transformer is connected to the power line to transmit the power. The transformer includes a supporting body, a plurality of magnetic conductive elements and a coil. The supporting body includes a first side and a second side. The magnetic conductive elements are disposed on the first side of the supporting body, and the magnetic conductive elements are arranged adjacent to each other. The coil is wound on the second side of the supporting body, and the coil includes an internal threading wire extending into the first side of the supporting body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a circuit diagram of a wireless charging device according to an embodiment of the present invention.

FIG. 2 is an exploded schematic diagram of a transformer according to an embodiment of the present invention.

FIG. 3 is a schematic top view of a transformer according to an embodiment of the present invention.

FIG. 4 is an enlarged schematic diagram of a transformer at a wire threading location according to an embodiment of the present invention.

FIG. 5 is a schematic cross-sectional view showing the threading wire extending downward along the through hole.

FIGS. 6 and 7 are bottom and side views respectively showing the assembly of the threading wire in the elongated slot.

### DETAILED DESCRIPTION OF THE INVENTION

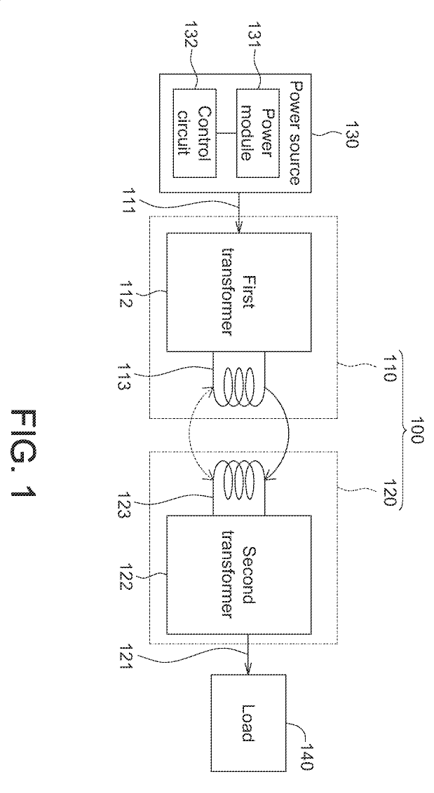

Referring to FIG. 1, a circuit diagram of a wireless charging device 100 is illustrated. The wireless charging device 100 includes a transmitter assembly 110 and a receiver assembly 120. The transmitter assembly 110 includes a first power line 111 and a first transformer 112. The receiver assembly 120 includes a second power line 121 and a second transformer 122. The transmitter assembly 110 is connected to a power source 130 via the first power line 111, and the receiver assembly 120 is connected to a load 140 (e.g., a battery of a device to be charged) via the second power line 121. When the power source 130 supplies a power to the transmitter assembly 110, the current passes through the primary coil 113 of the first transformer 112 to generate magnetic flux. When the secondary coil 123 of the second transformer 122 is positioned near the primary coil 113, the magnetic flux is coupled to the secondary coil 123, that is, the magnetic field generated by the primary coil 113 induces a voltage in the secondary coil 123, thereby generating an induced current in the secondary coil 123. Therefore, the induced current in the secondary coil 123 can charge the battery of the device to be charged. In other words, the wireless charging device 100 can achieve wireless transmission of electrical signals through near-field magnetic coupling.

The power source 130 may include a power module 131 and a control circuit 132. The control circuit 132 is used to control the voltage and current output by the power module 131. The first power line 111 is electrically connected to the power source 130 to provide a power input. The first transformer 112 is connected to the first power line 111, and the first transformer 112 can transmit a power to the second transformer 122 of the receiver assembly 120 through near-field magnetic coupling. The following is a description of the internal structure of the transformer. Since the internal structures of the first and second transformers 112 and 122 are similar, the following description is not limited to the first transformer 112 or the second transformer 122.

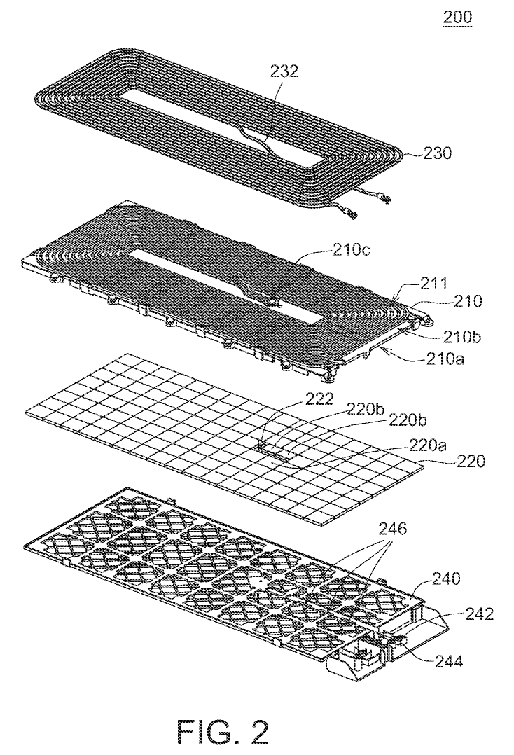

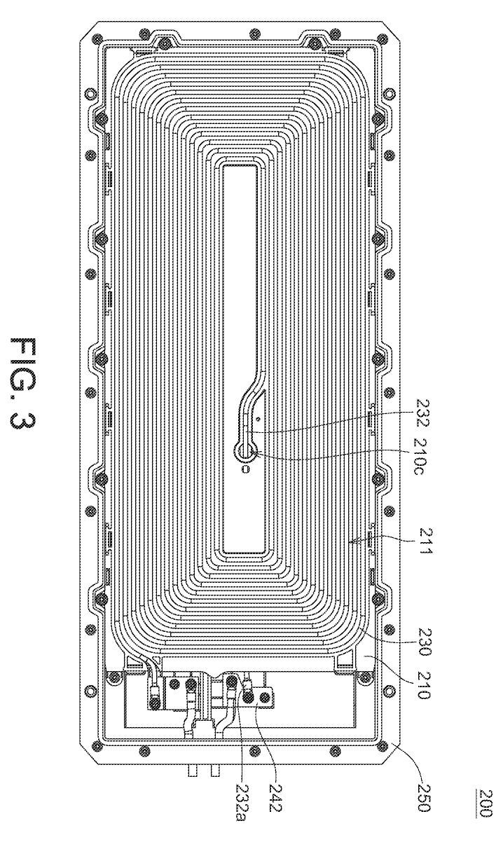

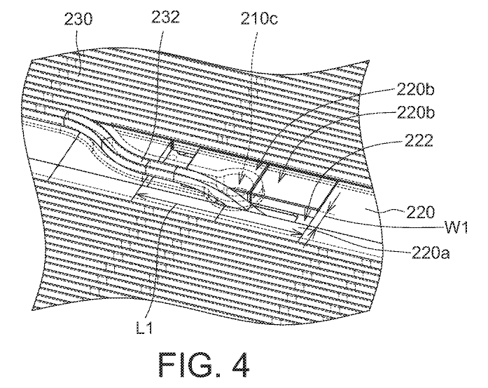

Referring to FIGS. 2 - 4, FIG. 2 is a schematic diagram of an exploded view of a transformer 200 according to an embodiment of the present invention, FIG. 3 is a schematic diagram of a top view of the transformer 200 according to an embodiment of the present invention, and FIG. 4 is a schematic diagram of an enlarged view of the transformer 200 at wire threading location according to an embodiment of the present invention. The transformer 200 may be the first transformer 112 or the second transformer 122 mentioned above. The transformer 200 may be disposed in a ground/wall assembly and/or a vehicle assembly. The ground/wall assembly has a transmitter assembly, and the vehicle assembly has a receiver assembly. The ground/wall assembly and vehicle assembly can be wirelessly charged through near-field magnetic coupling. The vehicle assembly may include an automated guided vehicle (AGV) or an autonomous mobile robot (AMR).

In one embodiment, the transformer 200 includes a supporting body 210, a plurality of magnetic conductive elements 220, a coil 230 and a supporting frame 240. The supporting body 210 may be a winding frame, and a winding groove 211 for accommodating the coil 230 is disposed on one side of the supporting body 210. As shown in FIG. 2, the supporting body 210 has a first side 210a, a second side 210b, and at least one through hole 210c penetrating the first side 210a and the second side 210b, but the through hole 210c may not be required or may be replaced by other structures. The magnetic conductive elements 220 are disposed on the first side 210a of the supporting body 210, and the magnetic conductive elements 220 are arranged adjacent to each other. In addition, the coil 230 is wound on the second side 210b of the supporting body 210, that is, wound in the winding groove 211, and the coil 230 includes an internal threading wire 232 extending into the first side 210a of the supporting body 210 through the through hole 210c. As shown in FIGS. 3 and 4, the threading wire 232 extends parallel to the top of the magnetic conductive element 220, and then passes through the notch 222 of the magnetic conductive element 220 in an oblique downward direction to enter the area below the notch 222.

The magnetic conductive element 220 is a magnetic core, and may be made of a ferrite core. The magnetic conductive elements 220 are arranged in a grid or other shapes, for example. The magnetic conductive elements 220 are arranged in an array and adjacent to each other, and the size of the magnetic conductive element 220 is adjustable. For example, in order to allow the threading wire 232 to pass through the through hole 210c and enter the first side 210a of the supporting body 210, at least one of the magnetic conductive elements 220 forms a notch 222 at a position corresponding to the through hole 210c, and the notch 222 is used for the threading wire 232 to pass through.

The area or size of at least one magnetic conductive element 220b forming the notch 222 is less than the area or size of other magnetic conductive elements 220a surrounding the at least one magnetic conductive element 220b among the magnetic conductive elements 220. For example, in FIG. 2, at least one second magnetic conductive element 220b having a second area smaller than the first area is added to a plurality of first magnetic conductive elements 220a arranged regularly. The number of the second magnetic conductive elements 220b can be one, two, or more than two. Since the second magnetic conductive element 220b and the first magnetic conductive element 220a have different areas or sizes, a notch 222 with a larger gap is formed between one side of the second magnetic conductive element 220b and one side of the first magnetic conductive element 220a. Alternatively, the notch 222 may also be formed on a side of the second magnetic conductive element 220b being recessed inward.

In addition, the notch 222 may also be formed by cutting a portion of the second magnetic conductive element 220b, so that the area of the second magnetic conductive element 220b is smaller than the area of the first magnetic conductive element 220a.

In addition, the notch 222 may also be formed by irregularly arranging the second magnetic conductive elements 220b. For example, the second magnetic conductive element 220b has an irregular shape, such as a trapezoid, a triangle or an unequal-sided geometric shape, and the first magnetic conductive elements 220a may have a regular shape or an equilateral shape such as a square. Therefore, in the regularly arranged first magnetic conductive elements 220a, at least one irregularly shaped or irregularly arranged second magnetic conductive element 220b is added to form the required notch 222 near the through hole 210c.

In one embodiment, the width W1 of the notch 222 is approximately 1.5 to 2.5 times the diameter of the threading wire 232. In addition, the length L1 of the notch 222 may be determined according to the descending height H1 of the threading wire 232 from the second side 210b to the first side 210a of the supporting body 210 and the inlet/outlet angle θ of the threading wire 232. When the descending height H1 of the threading wire 232 decreases or the inlet/outlet angle θ increases, the length L1 of the notch 222 may decrease relatively; conversely, when the descending height H1 of the threading wire 232 increases or the inlet/outlet angle θ decreases, the length L1 of the notch 222 may increase relatively.

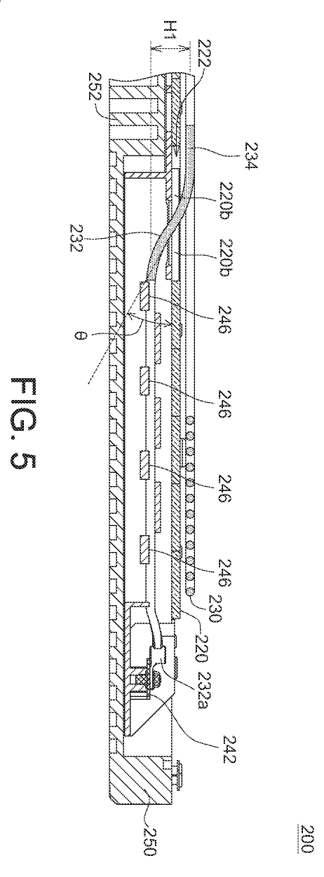

Referring to FIG. 5, a cross-sectional view showing the threading wire 232 extending downward along the through hole 210c is illustrated. In one embodiment, when the descending height H1 of the threading wire 232 is a fixed value, the larger the inlet/outlet angle θ of the threading wire 232 is, the greater the magnetic flux at the notch 222 along with the slope of the current is. In order to suppress the influence of magnetic leakage on the threading wire 232, the size of the notch 222 should not be too large, and the inlet/outlet angle θ of the threading wire 232 is preferably controlled between 30 and 60 degrees to avoid the inlet/outlet angle θ of the threading wire 232 being too large to reduce the electromagnetic induction efficiency and affect the charging performance.

In addition, the outer portion of the threading wire 232 passing through the notch 222 may be coated with a magnetic shielding material 234. The magnetic shielding material 234 may be, for example, a ferrite sheet or a high-permeability alloy, which may prevent the influence of magnetic leakage on the threading wire 232. In addition, a low friction coating or an insulating coating (such as a polyimide film) may be used in the notch 222 to prevent short circuit or extra loss when the threading wire 232 contacts the surface of the magnetic conductive elements 220, thereby reducing coil friction loss.

In addition, the second magnetic conductive element 220b of a smaller size is provided around the threading wire 232 to prevent the magnetic flux from leaking out and to keep the magnetic field concentrated, thereby avoiding the notch 222 being too large to cause a divergence of the magnetic flux.

In one embodiment, the threading wire 232 may be formed by multi-strand twisted wires or a flexible flat wire. The threading wire 232 may select the appropriate number of strands and wire diameter according to the current demand, and the multi-strand twisted wires have higher compliance when passing through the notch 222, thereby reducing loss and mechanical stress. In addition, multi-strand twisted wires may effectively reduce skin effect and proximity effect losses at high frequencies, thereby suitable for use under the operating frequency of wireless charging.

Referring to FIGS. 2, 5, and 6, the transformer 200 may include a wire outlet bracket 242, which is disposed on one side of the support bracket 240 and is used to fix an outlet terminal 232a of the threading wire 232. In addition, the transformer 200 may include a plurality of fixers 246 disposed in an elongated slot 244 of the support frame 240 along the routing direction of the threading wire 232 to fix the routing direction of the threading wire 232 so that the threading wire 232 extends substantially horizontally. In one embodiment, the transformer 200 may further include a housing 250 disposed on the bottom surface of the support frame 240. The outer surface of the housing 250 has a plurality of heat dissipation fins 252 to improve the heat dissipation efficiency of the transformer 200.

As shown in FIGS. 2, 5, and 6, when the threading wire 232 enters the first side 210a of the supporting body 210, the threading wire 232 enters the elongated slot 244 of the support frame 240 and extends horizontally along the elongated slot 244. Afterwards, the outlet terminal 232a of the threading wire 232 may be fixed to one side of the support frame 240 through the wire outlet bracket 242 to serve as a power input port or output port. The fixers 246 are disposed in the elongated slot 244. The fixers 246 may include a hook 247 or other structures.

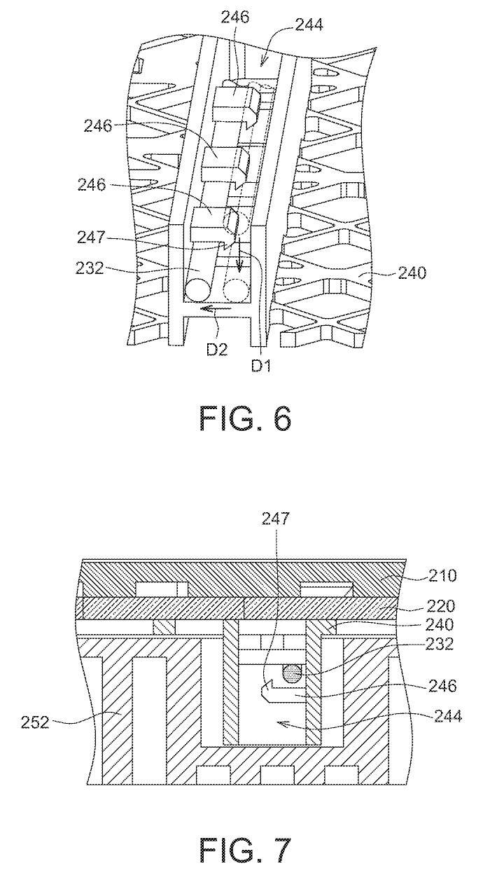

Referring to FIGS. 6 and 7, a bottom schematic diagram and a side schematic diagram of assembling the threading wire 232 in the elongated slot 244 are respectively illustrated. When assembling the threading wire 232, the threading wire 232 is moved from the bottom side of the elongated slot 244 to the top side in the direction D1 (see FIG. 6), so that the threading wire 232 passes through the outer side of one of the fixers 246, and then the threading wire 232 is moved from the outer side of the fixers 246 to the inner side in the direction D2 (see FIG. 6), so that the threading wire 232 moves into the hooks 247 of the fixers 246. Next, as shown in FIG. 7, the housing 250 is assembled on the support frame 240, and the magnetic conductive elements 220 are fixed between the support frame 240 and the supporting body 210. Afterwards, the outlet terminal 232a of the threading wire 232 is fixed on the wire outlet bracket 242, and the installation procedure of the coil 230 is completed.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transformer, comprising:
a supporting body including a first side and a second side;
a plurality of magnetic conductive elements disposed on the first side of the supporting body, and the magnetic conductive elements being arranged adjacent to each other; and
a coil wound around the second side of the supporting body, wherein the coil includes an internal threading wire extending into the first side of the supporting body.

2. The transformer of claim 1, wherein the supporting body comprises at least a through hole passing through the first side and the second side, at least one of the magnetic conductive elements forms a notch at a position corresponding to the through hole, and the through hole and the notch are configured for the threading wire to pass through.

3. The transformer of claim 2, wherein a width of the notch is 1.5 to 2.5 times a diameter of the threading wire.

4. The transformer of claim 2, wherein the notch is formed on one side of the at least one magnetic conductive element being recessed inward.

5. The transformer of claim 2, wherein an area of the at least one magnetic conductive element is less than an area of one of the other magnetic conductive elements surrounding the at least one magnetic conductive element.

6. The transformer of claim 2, wherein the notch is formed by cutting a portion of the at least one magnetic conductive element.

7. The transformer of claim 2, wherein the notch is formed by an irregularly arrangement of the at least one magnetic conductive element among the other magnetic conductive elements.

8. The transformer of claim 7, wherein the irregular arrangement includes disposing at least one magnetic conductive element having a different area or shape from that of the other magnetic conductive elements near the corresponding through hole.

9. The transformer of claim 1, wherein an outer portion of the threading wire is covered with a magnetic shielding material.

10. The transformer of claim 1, wherein the threading wire entering the first side of the supporting body has an inclined angle of less than or equal to 60 degrees.

11. The transformer of claim 10, wherein the inclined angle is between 30 and 60 degrees.

12. The transformer of claim 1, wherein the threading wire is formed by multi-strand twisted wires or a flexible flat wire.

13. The transformer of claim 1, wherein the supporting body is a winding frame, and a winding groove is disposed on one side of the winding frame for accommodating the coil.

14. The transformer of claim 1, further comprising a wire outlet bracket disposed on the first side of the supporting body, and one terminal of the threading wire passing through the through hole and being fixed to the wire outlet bracket.

15. The transformer of claim 1, further comprising at least one fixer disposed on the first side of the supporting body, and the fixer being configured to fix the threading wire entering the first side of the supporting body.

16. The transformer of claim 15, wherein the fixer is disposed in an elongated slot, and the elongated slot is configured to accommodate the threading wire.

17. The transformer of claim 15, wherein the fixer comprises a hook.

18. The transformer of claim 1, further comprising a housing arranged on the first side of the supporting body, and at least a heat dissipation fin being disposed on an outer surface of the housing.

19. A wireless charging device, comprising:
a power line for power input; and
a transformer connected to the power line to transmit the power, the transformer comprising:
a supporting body including a first side and a second side;
a plurality of magnetic conductive elements disposed on the first side of the supporting body, and the magnetic conductive elements being arranged adjacent to each other; and
a coil wound around the second side of the supporting body, wherein the coil includes an internal threading wire extending into the first side of the supporting body.

20. The wireless charging device of claim 19, wherein the coil is a primary coil or a secondary coil.

21. The wireless charging device of claim 19, wherein the transformer is disposed in a ground/wall assembly and/or a vehicle assembly, the ground/wall assembly has a transmitter assembly, and the vehicle assembly has a receiver assembly.

22. The wireless charging device of claim 19, wherein the supporting body is a winding frame, and a winding groove is disposed on one side of the winding frame for accommodating the coil.

23. The wireless charging device of claim 19, wherein the supporting body includes at least one through hole passing through the first side and the second side, and at least one of the magnetic conductive elements forms a notch at a position corresponding to the through hole, and the through hole and the notch are configured for the threading wire to pass through.

24. The wireless charging device of claim 23, wherein a width of the notch is 1.5 to 2.5 times a wire diameter of the threading wire.

25. The wireless charging device of claim 23, wherein the notch is formed on one side of the at least one magnetic conductive element being recessed inward.

26. The wireless charging device of claim 23, wherein an area of the at least one magnetic conductive element is less than an area of one of the other magnetic conductive elements surrounding the at least one magnetic conductive element.

27. The wireless charging device of claim 23, wherein the notch is formed by cutting a portion of the at least one magnetic conductive element.

28. The wireless charging device of claim 23, wherein the notch is formed by an irregularly arrangement of the at least one magnetic conductive element among the other magnetic conductive elements.

29. The wireless charging device of claim 28, wherein the irregular arrangement includes disposing at least one magnetic conductive element having a different area or shape from that of the other magnetic conductive elements at a position near the corresponding to the through hole.

30. The wireless charging device of claim 19, wherein an outer portion of the threading wire is covered with a magnetic shielding material.

31. The wireless charging device of claim 19, wherein the threading wire entering the first side of the supporting body has an inclined angle of less than or equal to 60 degrees.

32. The wireless charging device of claim 31, wherein the inclined angle is between 30 and 60 degrees.

33. The wireless charging device of claim 19, wherein the threading wire is formed by multi-strand twisted wires or a flexible flat wire.

34. The wireless charging device of claim 19, further comprising a wire outlet bracket disposed on the first side of the supporting body, and one terminal of the threading wire passing through the through hole and being fixed to the wire outlet bracket.

35. The wireless charging device of claim 19, further comprising at least one fixer disposed on the first side of the supporting body, and the fixer being configured to fix the threading wire entering the first side of the supporting body.

36. The wireless charging device of claim 35, wherein the fixer is disposed in an elongated slot, and the elongated slot is configured to accommodate the threading wire.

37. The wireless charging device of claim 35, wherein the fixer comprises a hook.

38. The wireless charging device of claim 19, further comprising a housing arranged on the first side of the supporting body, and at least a heat dissipation fin being disposed on an outer surface of the housing.
